(19) United States
(12) Patent Application Publication
(10) Pub. No.: US 2012/0019181 A1
(43) Pub. Date: Jan. 26, 2012

(54) Power converter for rotating electric machine

(75) Inventor: Takashi Suzuki, Obu-city (JP)

(73) Assignee: DENSO CORPORATION, Kariya-city (JP)

(21) Appl. No.: 13/135,479

(22) Filed: Jul. 6, 2011

(30) Foreign Application Priority Data
Jul. 23, 2010 (JP) 2010-165806

(51) Int. Cl. H02H 7/08

(52) U.S. Cl. 318/400.21

(57) ABSTRACT

A power converter for converting power supplied to a rotating electric machine that includes windings of N-phase (N≧2), includes an inverter section, a voltage detecting portion, one or more resistors, and an abnormality detecting portion. The voltage detecting portion detects a voltage applied to each winding of M-phase, where 1≦M<N. Each resistor is coupled between a corresponding winding of (N−M)-phase whose voltage is not detected and a high-potential side or a low-potential side of the power source. The abnormality detecting portion detects abnormality based on the voltage detected by the voltage detecting portion. At least one of the resistors is coupled between the corresponding winding and the high-potential side of the power source.

### CROSS REFERENCE TO RELATED APPLICATIONS

The present application is based on and claims priority to Japanese Patent Application No. 2010-165806 filed on Jul. 23, 2010, the contents of which are incorporated in their entirety herein by reference.

### BACKGROUND OF THE INVENTION

1. Field of the Invention

The present invention relates to a power converter that converts power supplied to a rotating electric machine.

2. Description of the Related Art

Conventionally, a power converter that converts power supplied to a rotating electric machine by turning on and off a plurality of switching devices is known. For example, when a winding of the rotating electric machine breaks, the rotating electric machine cannot output a predetermined torque and mechanical apparatus, such as a gear, connected with an output shaft of a motor may be damaged. JP-A-2006-50707 discloses a motor drive unit including a bias circuit that applies bias voltage to one of electric supply lines to detect abnormality of the electric supply lines.

However, because the motor drive unit detects voltages of the electric supply lines of all phases, the number of voltage detecting points is large, and a process of detecting abnormality is complicated.

### SUMMARY OF THE INVENTION

In view of the foregoing problems, it is an object of the present invention to provide a power converter that can detect abnormality with a simple process.

A power converter according to an aspect of the present invention converts power supplied from a power source to a rotating electric machine, and the rotating electric machine includes windings of N-phase, where N is an integer that satisfies a relationship of N≧2. The power converter includes an inverter section, a voltage detecting portion, one or more resistors, and an abnormality detecting portion. The inverter section includes an N-pair of switching devices. Each pair of switching devices includes a high-potential side switching device and a low-potential side switching device. The high-potential side switching device is coupled with a high-potential side of the power source and the low-potential side switching device is coupled with a low-potential side of the power source. Each pair of switching devices is coupled with a corresponding one of the windings of N-phase. The voltage detecting portion detects a voltage applied to each of the windings of M-phase, where M is an integer that satisfies a relationship of 1≦M<N. Each resistor is coupled between a corresponding one of the windings of (N−M)-phase whose voltage is not detected and a high-potential side or a low-potential side of the power source. The abnormality detecting portion detects abnormality based on the voltage detected by the voltage detecting portion. At least one of the resistors is coupled between the corresponding winding and the high-potential side of the power source.

In the power converter, the voltage detecting portion detects the voltage applied to each of the windings of M-phase that does not have a resistor with the high-potential side or the low-potential side of the battery and the voltage detecting portion does not detect a voltage applied to each of the windings of (N−M)-phase which have the resistor with the high-potential side or the low-potential side of the battery. Because the number of voltage detecting positions is reduced, the number of components for detecting the voltage can be reduced. Furthermore, because the resistor is disposed between the winding of the phase whose voltage is not detected and the high-potential side or the low-potential side of the power source, the voltage detected by the voltage detecting portion depends on the presence of abnormality or an abnormal portion. Accordingly, the number of voltage detecting positions can be reduced, and abnormality can be detected with a simple process.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a schematic diagram showing a power converter according to a first embodiment;

FIG. 2 is a flowchart showing an abnormality detecting process performed by the power converter according to the first embodiment;

FIG. 3 is a schematic diagram showing a power converter according to a second embodiment;

FIG. 4 is a schematic diagram showing a power converter according to a third embodiment; and

FIG. 5 is a schematic diagram showing a power converter according to other embodiment.

### DETAILED DESCRIPTION OF THE PREFERRED EMBODIMENTS

### First Embodiment

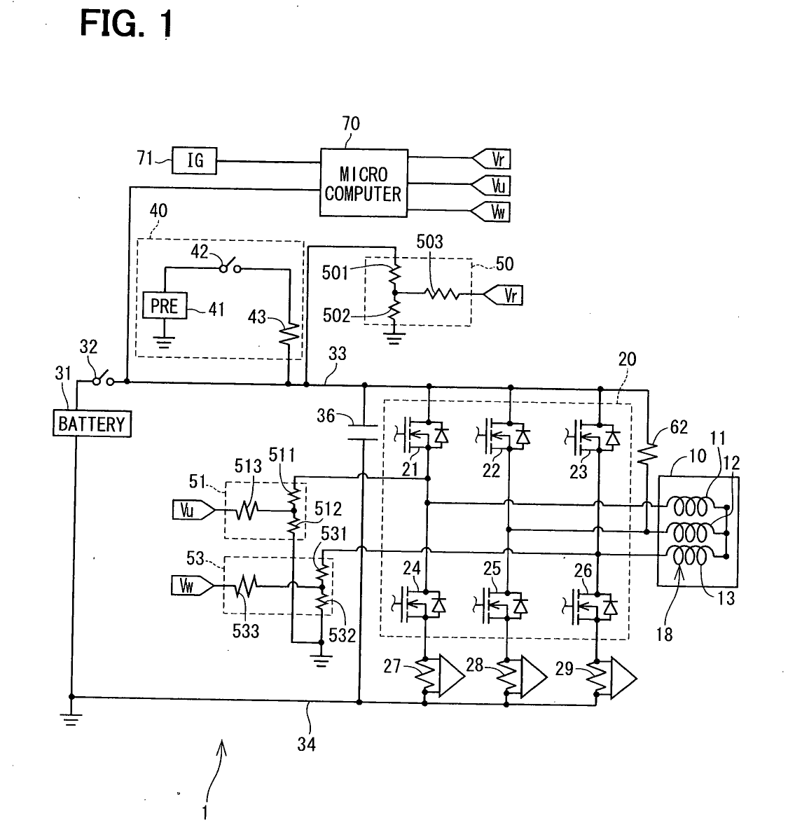

A power converter 1 according to a first embodiment will be described with reference to FIG. 1. The power converter 1 converts power supplied to a motor 10 which is an example of a rotating electric machine. The power converter 1 and the motor 10 can be applied to an electric power steering apparatus (EPS) for assisting a steering operation of a vehicle.

The motor 10 is a three brushless motor and includes a rotor and a stator which are not shown. The rotor is a circular plate having a permanent magnet on a surface thereof and has magnetic poles. The rotor is housed in the stator and is rotatably held by the stator. The stator includes three protruding portions that protrude radially-inward and are located at each predetermined angle. At the three protruding portions, a U-phase coil 11, a V-phase coil 12, and a W-phase coil 13 are respectively winded. The U-phase coil 11, the V-phase coil 12, and the W-phase coil 13 respectively correspond to a U-phase, a V-phase, and W-phase and configurate a set of windings 18. Although each of the U-phase coil 11, the V-phase coil 12, and the W-phase coil 13 is illustrated as one coil, each of the U-phase coil 11, the V-phase coil 12, and the W-phase coil 13 may also include a plurality of coils.

The power converter 1 includes an inverter section 20, a U-phase voltage detecting portion 51, a W-phase voltage detecting portion 53, a pull-up resistor 62, and a microcomputer 70. The inverter section 20 is a three-phase inverter. The inverter section 20 includes six switching devices which are bridge-connected to switch power supply to each of the U-phase coil 11, the V-phase coil 12, and the W-phase coil 13 in the set of windings 18. In the present embodiment, the six switching devices are metal-oxide-semiconductor field effect transistors (MOSFETs) 21-26.

Drains of the MOSFETs 21-23 are coupled with a cathode of a battery 31. Sources of the MOSFETs 21-23 are coupled with drains of the MOSFETs 24-26, respectively. Sources of the MOSFETs 24-26 are coupled with the ground through shunt resistors 27-29, respectively.

A connection point of the MOSFET 21 and the MOSFET 24 are coupled with an end of the U-phase coil 11. A connection point of the MOSFET 22 and the MOSFET 25 are coupled with an end of the V-phase coil 12. A connection point of the MOSFET 23 and the MOSFET 26 are coupled with an end of the W-phase coil 13.

Between the MOSFETs 24-26 and the ground, the shunt resistors 27-29 are coupled. Specifically, the shunt resistor 27 is coupled between the MOSFET 24 and the ground, the shunt resistor 28 is coupled between the MOSFET 25 and the ground, and the shunt resistor 29 is coupled between the MOSFET 26 and the ground. By detecting voltage values or current values of electric current that flow in the shunt resistors 27-29, electric current that flow to the coils 11-13 can be detected.

The MOSFETs 21-23 can function as high-potential side switching devices in the inverter section 20. The MOSFETs 24-26 can function as low-potential side switching devices in the inverter section 20.

The MOSFETs 21-23 are coupled with the cathode of the battery 31 through a battery line 33. The shunt resistors 27-29 are coupled with the ground through a ground line 34. In the present embodiment, the battery line 33 can function as a high-potential side of a battery and the ground line 24 can function as a low-potential side of a battery. In the following description, in a path from the cathode side of the battery 31 to the ground, a portion adjacent to the battery 31 is upstream and a portion adjacent to the ground is downstream.

On the battery line 33 between the cathode and the inverter section 20, a power source relay 32 is provided. The microcomputer 70 controls an on-off state of the power source relay 32, and thereby flow of electric current between the battery 31 and the inverter section 20 and the motor 10 is allowed and is cut off. The power source relay 32 is a so-called normally-open power source relay. When the power source relay 32 does not receive an on-command from the microcomputer 70, the power source relay 32 is in an open state, that is, an off-state, and the flow of electric current is cut off. When the power source relay 32 receives an on-command from the microcomputer 70, the power source relay 32 becomes a close state, that is, an on-state, and the flow of electric current is allowed.

An end of a capacitor 36 is coupled with the battery line 33 at a point between the power source relay 32 and the inverter section 20. The other end of the capacitor 36 is coupled with the ground line 34 at a point between the inverter section 20 and the battery 31. In other words, the capacitor 36 is disposed between the battery 31 and the inverter. section 20. The capacitor 36 stores electric charge, and thereby assisting the power supply to the MOSFETs 21-26 and restricting ripple current that is generated when power is supplied from the battery 31 to the motor 10.

A precharge circuit 40 is coupled between a connection point of the capacitor 36 and the battery line 33 and the power source relay 32. The precharge circuit 40 includes a precharge battery (PRE) 41, a precharge relay 42, and a precharge resistor 43. The precharge battery 41 has a voltage lower than a voltage of the battery 31. In the present embodiment, the voltage of the battery (hereafter, referred to as a battery voltage Vba) is 12 V, and the voltage of the precharge battery 41 (hereafter, referred to as a precharge voltage Vpre) is 5V.

The microcomputer 70 also controls an on-off state of the precharge relay 42, and flow of electric current between the precharge battery 41 and the battery line 33 is allowed and cut off. In the present embodiment, the precharge resistor 43 is disposed between the precharge relay 42 and the battery line 33. Due to the precharge resistor 43, large current does not momentarily flow from the precharge battery 41 to the capacitor 36 when the microcomputer 70 turns on the precharge relay 42. The precharge resistor 43 may have any resistance. For example, the precharge resistor 43 has a resistance of 10 Ω or 100 Ω. The precharge resistor 43 is not necessary when a function for restricting excess output from the precharge battery 41 is provided.

A relayed voltage detecting portion 50 detects a relayed voltage Vr of the battery line 33 located downstream of the power source relay 32. An end of the relayed voltage detecting portion 50 is coupled with the battery line 33 at a point between the precharge circuit 40 and the capacitor 36, and the other end of the relayed voltage detecting portion 50 is coupled with the ground. The relayed voltage detecting portion 50 includes three resistors 501, 502, 503. The resistors 501, 502 are coupled in series and configurate a voltage dividing resistor. Resistances of the resistors 501, 502 are determined so that a voltage applied to a connection point of the resistors 501, 502 can be detected by the microcomputer 70. The resistor 503 is coupled between the connection point of the resistors 501, 502 and the microcomputer 70. Due to the resistor 503, excess current does not flow to the microcomputer 70.

In the present embodiment, the power converter 1 includes the U-phase voltage detecting portion 51 that detects voltage applied to the U-phase coil 11 and the W-phase voltage detecting portion 53 that detects voltage applied to the W-phase coil 13. The pull-up resistor 62 is coupled between the battery 31 and the V-phase coil 12. A voltage detecting portion that detects voltage applied to the V-phase is not provided.

The U-phase voltage detecting portion 51 detects the voltage applied to the U-phase coil 11, that is, a terminal voltage of the U-phase coil 11 (hereafter, referred to as a U-phase terminal voltage Vu). An end of the U-phase voltage detecting portion 51 is coupled between the MOSFET 21 and the MOSFET 24, and the other end of the U-phase voltage detecting portion 51 is coupled with the ground. The U-phase voltage detecting portion 51 includes three resistors 511, 512, 513 in a manner similar to the relayed voltage detecting portion 50. The resistors 511, 512 are coupled in series and configurate a voltage dividing resistor. Resistances of the resistors 511, 512 are determined so that a voltage applied to a connection point of the resistors 511, 512 can be detected by the microcomputer 70. The resistor 513 is coupled between the connection point of the resistors 511, 512 and the microcomputer 70. Due to the resistor 513, excess current does not flow to the microcomputer 70.

The W-phase voltage detecting portion 53 detects the voltage applied to the W-phase coil 13, that is, a terminal voltage of the W-phase coil 13 (hereafter, referred to as a W-phase terminal voltage Vw). An end of the W-phase voltage detecting portion 53 is coupled between the MOSFET 23 and the MOSFET 26, and the other end of the W-phase voltage detecting portion 53 is coupled with the ground. The W-phase voltage detecting portion 53 includes three resistors 531, 532, 533 in a manner similar to the U-phase voltage detecting portion 51. The resistors 531, 532 are coupled in series and configurate a voltage dividing resistor. Resistances of the resistors 531, 532 are determined so that a voltage applied to a connection point of the resistors 531, 532 can be detected by the microcomputer 70. The resistor 533 is coupled between the connection point of the resistors 531, 532 and the microcomputer 70. Due to the resistor 533, excess current does not flow to the microcomputer 70.

The pull-up resistor 62 is disposed between the V-phase coil 12 and the high-potential side of the battery 31. The pull-up resistor 62 couples the battery line 33 and the V-phase coil 12 on a downstream side of the power source relay 32. That is, in the present embodiment, the V-phase is pulled up by the pull-up resistor 62.

Examples of resistances of respective resistors included in the power converter 1 are described below. The pull-up resistor 62 has a resistance Rpull of 4120 Ω. In the U-phase voltage detecting portion 51, the resistor 511 has a resistance RupU of 3010 Ω, the resistor 512 has a resistance RdownU of 1000 Ω, and the resistor 513 has a resistance DdampU of 2400 Ω. In the U-phase voltage detecting portion 53, the resistor 531 has a resistance RupW of 3010 Ω, the resistor 532 has a resistance RdownW of 1000 Ω, and the resistor 533 has a resistance DdampW of 2400 Ω. The U-phase coil 11 has a resistance RmU of 0.01 Ω, the V-phase coil 12 has a resistance RmV of 0.01 Ω, and the W-phase coil 13 has a resistance RmW of 0.01 Ω.

The microcomputer 70 is a small computer including, for example, an integrated circuit. The microcomputer 70 is coupled with various parts and the detecting portions in the power converter 1. The microcomputer 70 includes a memory in which programs are stored. The microcomputer 70 executes various processes and controls coupled parts based on the programs.

The microcomputer 70 is coupled with the MOSFETs 21-26, the power source relay 32, and the precharge relay 42 through control lines. In FIG. 1, the control lines are not shown for the sake of convenience. The microcomputer 70 is coupled with an ignition power source (IG) 71. When a user of a vehicle turns on an ignition key, power is supplied from the ignition power source 71 to the microcomputer 70, and the microcomputer 70 starts to execute various processes.

The microcomputer 70 switches on-off states of the MOSFETs 21-26 by a pulse width modulation (PWM) control, and thereby controlling a torque and a rotating speed of the motor 10. When the power source relay 32 is turned on and the power supply to the inverter section 20 is allowed, the microcomputer 70 switches the on-off states of the MOSFETs 21-26. Accordingly, direct current from the battery 31 is converted into sine wave current having a different phase for each phase. The sine wave current having the different phase is applied to each of the U-phase coil 11, the V-phase coil 12, and the W-phase coil 13, and the motor 10 rotates due to a magnetic field by applying electric current. In this way, the microcomputer 70 controls a driving state of the motor 10 by switching the on-off state of the MOSFETs 21-26.

The microcomputer 70 acquires the relayed voltage Vr from the relayed voltage detecting portion 50. The microcomputer 70 acquires the U-phase terminal voltage Vu from the U-phase voltage detecting portion 51 and acquires the W-phase terminal voltage Vw from the W-phase voltage detecting portion 51

In the present embodiment, the microcomputer 70 detects abnormality in the inverter section 20, the coils 11-13, and the portion between the inverter section 20 and the coils 11-13.

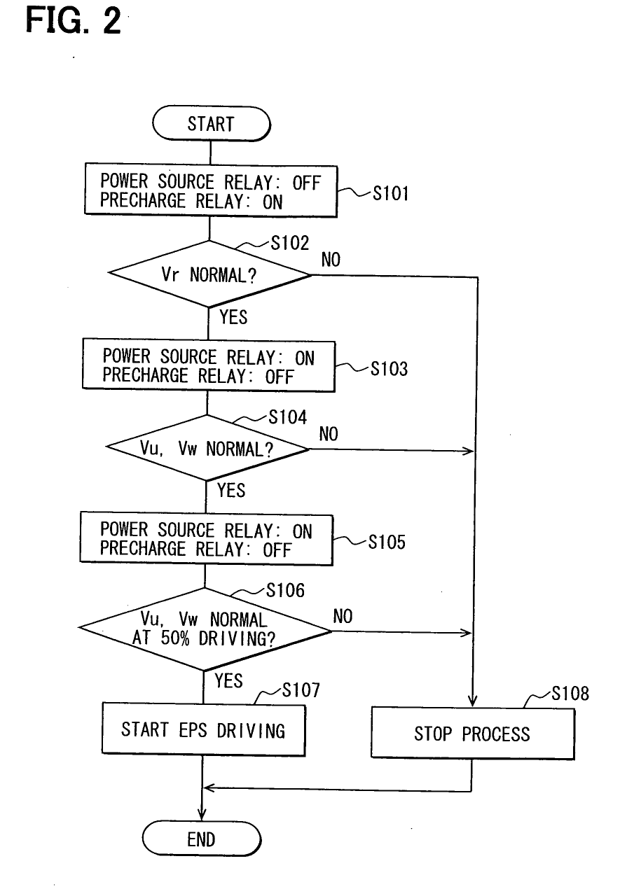

An abnormality detecting process will be described with reference to FIG. 2. The microcomputer 70 executes the abnormality detecting process when the ignition power source 71 is turned on.

At S101, the microcomputer 70 turns on the precharge relay 42. At this time, the power source relay 32 is not turned on and is in the off-state.

At S102, the microcomputer 70 acquires the relayed voltage Vr from the relayed voltage detecting portion 50 and determines whether the relayed voltage Vr is normal. Because the power source relay 32 is in the off-state and the precharge relay 42 is in the on-state, the relayed voltage Vr in the normal state is equal to the precharge voltage Vpre, that is, 5 V. Thus, the microcomputer 70 determines that the relayed voltage Vr is normal when the related voltage Vr is in a predetermined range including 5V. For example, the microcomputer 70 determines that the relayed voltage is normal when a relationship of 4.5≦Vr≦5.5 is satisfied. When the microcomputer 70 determines that the relayed voltage Vr is not normal, which corresponds to “NO” at S102, that is, when Vr<4.5 or Vr>5.5, the process proceeds to S108. When Vr≈0, the microcomputer 70 can determine that the capacitor 36 shorts out or one of the precharge battery 41 and the precharge relay 42 breaks down. When Vr≈12, the microcomputer 70 can determine that the power source relay 32 shorts out. When the microcomputer 70 determines that the relayed voltage Vr is normal, which corresponds to “YES” at S102, the process proceeds to S103.

At S103, the microcomputer 70 turns on the power source relay 32 and turns off the precharge relay 42. At S104, the microcomputer 70 acquires the U-phase terminal voltage Vu from the U-phase voltage detecting portion 51 and acquires the W-phase voltage Vw from the W-phase voltage detecting portion 53 and determines whether the U-phase terminal voltage Vu and the W-phase terminal voltage Vw are normal. The U-phase terminal voltage Vu in the normal state can be calculated from the following equation (1).

Vu=Vba×(RdownU)/(RupU+RmU+RdownU)×Rp1/(Rpull+RmV+Rp1) (1)

The W-phase terminal voltage Vw in the normal state can be calculated from the following equation (2).

Vw=Vba×(RdownW)/(RupW+RmW+RdownW)×Rp1/(Rpull+RmV+Rp1) (2)

Where, Rp1 is a combined resistance of the resistors 511, 512 as the voltage dividing resistor in the U-phase voltage detecting portion 51, the U-phase coil 11, the resistors 531, 532 as the voltage dividing resistor in the W-phase voltage detecting portion 53, and the W-phase coil 13. Rp1 can be calculated from the following equation (3).

Rp1={(RupU+RmU+RdownU)×(RupW+RmW+RdownW)}/{(RupU+RmU+RdownU)+(RupW+RmW+RdownW)} (3)

When the battery voltage Vba is 12 V, and each resistor has the above-described resistance, the U-phase terminal voltage Vu in the normal state is 0.98 V and the W-phase terminal voltage Vw in the normal state is 0.98 V.

In the present embodiment, the microcomputer 70 determines that the U-phase terminal voltage Vu and the W-phase terminal voltage Vw are normal when each of the U-phase terminal voltage Vu and the W-phase terminal voltage Vw is within a predetermined range including 0.98 V which is the value calculated by the above equations (1), (2). For example, the microcomputer 70 determines that the U-phase terminal voltage Vu and the W-phase terminal voltage Vw are normal when 0.8≦Vu≦1.2 and 0.8≦Vw≦1.2. When the microcomputer 70 determines that the U-phase terminal voltage Vu and the W-phase terminal voltage Vw are not normal, which corresponds to “NO” at S104, that is, when Vu<0.8, Vu>1.2, Vw<0.8, or Vw>1.2, the process proceeds to S108. Based on the U-phase terminal voltage Vu and the W-phase terminal voltage Vw, the microcomputer 70 can determine not only the presence of abnormality but also an abnormal portion. A method of determining the abnormal portion will be described later. When the microcomputer 70 determines that the U-phase terminal voltage Vu and the W-phase terminal voltage Vw are normal, which corresponds to “YES” at S104, the process proceeds to S105.

At S105, the power source relay 32 is turned on and the precharge relay 42 is turned off. At S106, the microcomputer 70 determines whether the U-phase voltage Vu and the W-phase terminal voltage Vw at a time when the MOSFETs 21-26 are driven at 50% phase by phase are normal. Specifically, the microcomputer 70 acquires the U-phase terminal voltage Vu and the W-phase terminal voltage Vw at when the MOSFET 21 and the MOSFET 24 are driven at 50% and determines whether the U-phase terminal voltage Vu and the W-phase terminal voltage Vw are normal. The microcomputer 70 also acquires the U-phase terminal voltage Vu and the W-phase terminal voltage Vw at when the MOSFET 22 and the MOSFET 25 are driven at 50% and determines whether the U-phase terminal voltage Vu and the W-phase terminal voltage Vw are normal. The microcomputer 70 also acquires the U-phase terminal voltage Vu and the W-phase terminal voltage Vw at when the MOSFET 22 and the MOSFET 25 are driven at 50% and determines whether the U-phase terminal voltage Vu and the W-phase terminal voltage Vw are normal.

The U-phase terminal voltage Vu and the W-phase terminal voltage Vw at when the MOSFETs of each phase are driven at 50% can be calculated from the following equations (4) and (5).

Vu=Vr×0.5 (4)

Vw=Vr×0.5 (5)

In the present embodiment, the microcomputer 70 determines that the U-phase terminal voltage Vu and the W-phase terminal voltage Vw at when the MOSFETs are driven at 50% phase by phase are normal when the U-phase terminal voltage Vu and the W-phase terminal voltage Vw are in a predetermined range including Vr×0.5. For example, the microcomputer 70 determines that the U-phase terminal voltage Vu and the W-phase terminal voltage Vw are normal when 0.9×Vr×0.5≦Vu≦1.1×Vr×0.5 and 0.9×Vr×0.5 Vw≦1.1×Vr×0.5. When the microcomputer 70 determines that the U-phase terminal voltage Vu and the W-phase terminal voltage Vw at when the MOSFETs are driven at 50% phase by phase are not normal, which corresponds to “NO” at S106, that is, when Vu<0.9×Vr×0.5, Vu>1.1×Vr×0.5, Vw<0.9×Vr×0.5, or Vw>1.1×Vr×0.5, the process proceeds to S108. When the microcomputer 70 determines that the U-phase terminal voltage Vu and the W-phase terminal voltage Vw at when the MOSFETs are driven at 50% phase by phase are normal, which corresponds to “YES” at S106, the process proceeds to S107.

At S107, the microcomputer 70 starts to drive the EPS. When the microcomputer 70 determines that the relayed voltage Vr is not normal, which corresponds to “NO” at S102, when the microcomputer 70 determines that the U-phase terminal voltage Vu and the W-phase terminal voltage Vw are not normal, which corresponds to “NO” at S104, or when the microcomputer 70 determines that the U-phase terminal voltage Vu and the W-phase terminal voltage Vw at when the MOSFETs are driven at 50% phase by phase are not normal, which corresponds to “NO” at S106, the process proceeds to S108 to stop the abnormality detecting process. For example, when the power source relay 32 is in the on-state, the microcomputer 70 turns off the power source relay 32.

Next, the method of determining an abnormal portion based on the U-phase terminal voltage Vu and the W-phase terminal voltage Vw at when the power source relay 32 is in the on-state and the precharge relay 42 is in the off-state will be described. When one of the MOSFETs 21-23 shorts out, the U-phase terminal voltage Vu and the W-phase terminal voltage Vw can be calculated from the following equations (6), (7).

Vu=Vba×{(RdownU)/(RupU+RdownU)} (6)

Vw=Vba×{(RdownW)/(RupW+RdownW)} (7)

In a case where the battery voltage Vba is 12 V, and each resistor has the above-described resistance, when one of the MOSFETs 21-23 shorts out, the U-phase terminal voltage Vu is 2.99 V and the W-phase terminal voltage Vw is 2.99 V. When one of the MOSFETs 24-26 shorts out, the U-phase terminal voltage Vu and the W-phase terminal voltage Vw are calculated from the following equations (8), (9).

Vu=0 (8)

Vw=0 (9)

The U-phase terminal voltage Vu and the W-phase terminal voltage Vw at when a U-phase wire breaks can be calculated from the following equations (10), (11).

Vu=0 (10)

Vw=Vba×(RdownW)/(Rpull+RmV+RupW+RmW+RdownW) (11)

In a case where the battery voltage Vba is 12 V and each resistor has the above-described resistance, when the U-phase wire breaks, the W-phase terminal voltage Vw is 1.48 V.

The U-phase terminal voltage Vu and the W-phase terminal voltage Vw at when a V-phase wire breaks can be calculated from the following equations (12), (13).

Vu=0 (12)

Vw=0 (13)

The U-phase terminal voltage Vu and the W-phase terminal voltage Vw at when a W-phase wire breaks can be calculated from the following equations (14), (15).

Vu=Vba×(RdownU)/(Rpull+RmV+RupU+RmU+RdownU) (14)

Vw=0 (15)

In a case where the battery voltage Vba is 12 V and each resistor has the above-described resistance, when the W-phase wire breaks, the W-phase terminal voltage Vu is 1.48 V

The U-phase wire includes a wire from the connection point of the MOSFET 21 and the MOSFET 24 to the U-phase coil 11 in addition to the U-phase coil 11. The V-phase wire includes a wire from the connection point of the MOSFET 22 and the MOSFET 25 to the V-phase coil 12 in addition to the V-phase coil 12. The W-phase wire includes a wire from the connection point of the MOSFET 23 and the MOSFET 26 to the W-phase coil 13 in addition to the

W-phase coil 13.

As described in the equations (6)-(15), the U-phase terminal voltage Vu and the W-phase terminal voltage Vw at when the power source relay 32 is in the on-state and the precharge relay 42 is in the off-state have different values in accordance with the abnormal portion. Thus, the microcomputer 70 can identify the abnormal portion based on the U-phase terminal voltage Vu and the W-phase terminal voltage Vw. For example, predetermined ranges including the values calculated from the equations (6)-(15) are set. When the U-phase terminal voltage Vu and the W-phase terminal voltage Vw are in the predetermined range, the microcomputer 70 can determine that abnormality occurs in a corresponding portion. When one of the MOSFETs 24-26 shorts out or when the V-phase wire breaks, the U-phase terminal voltage Vu=0, and the W-phase terminal voltage Vw=0. Thus, when the microcomputer 70 needs to discriminate which portion among the MOSFETs 24-26 and the V-phase has abnormality, the microcomputer 70 can identify the abnormal portion by executing another process.

As described above, the power converter 1 according to the present embodiment converts power supplied to the motor 10 that includes the set of windings including the U-phase coil 11, the V-phase coil 12, and the W-phase coil 13 corresponding to N-phase, where N is an integer that satisfy a relationship of N≧2. The inverter section 20 includes pairs of switching devices provided by the MOSFETs 21-23 and the MOSFETs 24-26 and being corresponding to the U-phase coil 11, the V-phase coil 12, and the W-phase coil 13. The U-phase voltage detecting portion 51 detects voltage applied to the U-phase coil 11, and the W-phase voltage detecting portion 53 detects voltage applied to the W-phase coil 13. The pull-up resistor 62 is coupled between the V-phase coil 12 whose voltage is not detected and the high-potential side of the battery 31. The microcomputer 70 detects abnormality based on the U-phase terminal voltage Vu and the W-phase terminal voltage Vw (S104 in FIG. 2).

In the present embodiment, the pull-up resistor 62 is coupled between the battery 31 and the V-phase coil 12 and the pull-up resistor 62 is not coupled between the battery 31 and each of the U-phase coil 11 and the W-phase coil 13. Then, the voltage applied to the U-phase coil 11 and the voltage applied to the W-phase coil 13 are detected and the voltage applied to the V-phase coil 12 is not detected. In this way, the voltages applied to all the coils 11-13 are not detected, and the number of voltage detecting positions is reduced. Thus, the number of components for detecting the voltages can be reduced and the cost can be reduced. In addition, because the pull-up resistor 62 is coupled between the V-phase coil 12 whose voltage is not detected and the battery 31, the U-phase terminal voltage Vu and the W-phase terminal voltage Vw have different values in accordance with the presence of abnormality and the abnormal portion. Accordingly, the number of voltage detecting positions can be reduced, and abnormality can be detected by the simple process.

In the present embodiment, the motor 10 is applied to the EPS. When the motor 10 has abnormality such as breaking of the coils 11-13, there is a possibility that a torque ripple of a steering wheel is large and thereby a driver has an uncomfortable feeling or an assist torque is not output depending on a steering angle. In the present embodiment, the microcomputer 70 detects abnormality such as breaking of the coils 11-13. Thus, the microcomputer 70 can immediately warn a driver, for example, by lightening a warning lamp or the microcomputer 70 can switch an operation mode of the motor 10 into a mode at breakdown so as to improve a safety.

The U-phase terminal voltage Vu detected by the U-phase voltage detecting portion 51 and the W-phase terminal voltage Vw detected by the

W-phase voltage detecting portion 53 has different values in accordance with an abnormal portion, the microcomputer 70 can identify the abnormal portion based on the detected voltages. In the present embodiment, the microcomputer 70 can function as an abnormality detecting portion, and S104 in FIG. 2 corresponds to a process as the function of the abnormality detecting portion.

### Second Embodiment

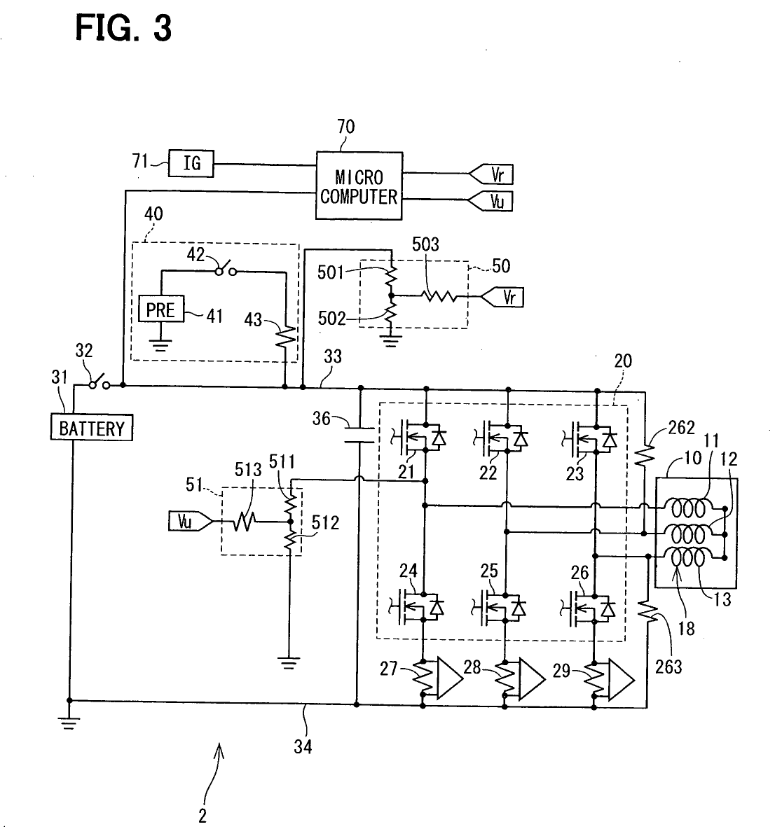

A power converter 2 according to a second embodiment will be described with reference to FIG. 3. In the present embodiment, only a voltage applied to the U-phase coil 11 is detected, and a voltage applied to the W-phase coil 13 is not detected. In other words, the power converter 2 includes the U-phase voltage detecting portion 51 and does not include a voltage detecting portion for detecting voltages applied to the V-phase coil 12 and the W-phase coil 13.

Between the V-phase coil 12 and the high-potential side of the battery 31, a pull-up resistor 262 is disposed. The pull-up resistor 262 couples the battery line 33 and the V-phase coil 12 on the downstream side of the power source relay 32. Between the W-phase coil 13 and the high-potential side of the battery 31, a pull-down resistor 263 is disposed. The pull-down resistor 263 couples the ground line 24 and the W-phase coil 13. In other words, in the present embodiment, the V-phase is pulled up by the pull-up resistor 262 and the W-phase is pulled down by the pull-down resistor 263. In the present embodiment, each of the pull-up resistor 262 and the pull-down resistor 263 corresponds to a resistor. The pull-up resistor 262 corresponds to a first resistor and the pull-down resistor 263 corresponds to a second resistor.

Examples of resistances of respective resistors included in the power converter 2 are described below. The pull-up resistor 262 has a resistance Rpu of 2000 Ω, the pull-down resistor 263 has a resistance Rpd of 1000 Ω. In the U-phase voltage detecting portion 51, the resistor 511 has a resistance RupU of 310 Ω, the resistor 512 has a resistance RdownU of 2000 Ω, and the resistor 513 has a resistance of RdampU of 2400 Ω. The U-phase coil 11 has a resistance RmU of 0.01 Ω, the V-phase coil 12 has a resistance RmV of 0.01 Ω, and the W-phase coil 13 has a resistance RmW of 0.01 Ω.

An abnormality detecting process according to the present embodiment is almost similar to the abnormality detecting process shown in FIG. 2. Thus, only a part different from the first embodiment will be described and a description about the other part will be omitted. At S104, the microcomputer 70 detects the U-phase terminal voltage Vu from the U-phase voltage detecting portion 51 and determines whether the U-phase terminal voltage Vu is normal. The U-phase terminal voltage Vu in the normal state can be calculated from the following equation (16).

Vu=Vba×(RdownU)/(RupU+RmU+DdownU)×Rp2/(Rpu+RmV+Rp2) (16)

Where, Rp2 is a combined resistance of the resistors 511, 512 as the voltage dividing resistor in the U-phase voltage detecting portion 51, the pull-down resistor 263 and the W-phase coil 13. Rp2 can be calculated from the following equation (17).

Rp2={(RupU+RmU+RdownU)×(RmW+Rpd)}/{(RupU+RmU+RdownU)+(RmW+Rpd)} (17).

In a case where the battery voltage Vba is 12 V and each resistor has the above-described resistance, the U-phase terminal voltage Vu in the normal state is 1.41 V.

In the present embodiment, the microcomputer 70 determines that the U-phase terminal voltage Vu is normal when the U-phase terminal voltage is in a predetermined range including 1.41 V. For example, the microcomputer 70 determines that the U-phase terminal voltage Vu is normal when 1.2≦Vu≦1.6. When the microcomputer 70 determines that the U-phase terminal voltage Vu is not normal, which corresponds to “NO” at S104, that is, when Vu<1.2 or Vu>1.6, the process proceeds to S108. When the microcomputer 70 determines that the

U-phase terminal voltage Vu is normal, which corresponds to “YES” at S104, the process proceeds to S105.

At S106, the microcomputer 70 determines whether the U-phase terminal voltage Vu at when the MOSFETs 21-26 are driven at 50% phase by phase. In the normal state, the U-phase terminal voltage at when the MOSFETs driven at 50% phase by phase is similar to that of the first embodiment. Thus, at S106, the microcomputer 70 determines that the U-phase terminal voltage is not normal when Vu<0.9×Vr×0.5 or when Vu>1.1×Vr×0.5, and the microcomputer 70 determines that the U-phase terminal voltage is normal when 0.9×Vr×0.5<Vu<1.1×Vr×0.5.

Next, the method of determining an abnormal portion based on the U-phase terminal voltage at when the power source relay 32 is in the on-state and the precharge relay 42 is in the off-state will be described. The U-phase terminal voltage Vu at when one of the MOSFETs 21-23 shorts out can be calculated from the following equation (18).

Vu=Vba×{(RdownU)/(RupU+RdownU)} (18)

In a case where the battery voltage Vba is 12 V and each resistor has the above-described resistance, the U-phase terminal voltage Vu at when one of the MOSFETs 21-23 shorts out is 4.79 V. When one of the MOSFETs 24-26 shorts out, the U-phase terminal voltage Vu becomes a value calculated from the following equation (19).

Vu=0 (19).

When the U-phase wiring breaks, the U-phase terminal voltage Vu becomes a value calculated from the following equation (20).

Vu=0 (20)

When the V-phase wiring breaks, the U-phase terminal voltage Vu becomes a value calculated from the following equation (21).

Vu=0 (21)

When the W-phase wiring breaks, the U-phase terminal voltage Vu can be calculated from the following equation (22).

Vu=Vba×(RdownU)/(Rpu+RmV+RupU+RmU+RdownU) (22)

In a case where the battery voltage Vba is 12 V and each resistor has the above-described resistance, the U-phase terminal voltage Vu at when the W-phase wiring breaks is 3.42 V.

As shown in the equations (18)-(22), the U-phase terminal voltage Vu at when the power source relay 32 is in the on-state and the precharge relay 42 is in the off-state has a different value in accordance with an abnormal portion. Thus, the microcomputer 70 can identify the abnormal portion based on the U-phase terminal voltage Vu. For example, predetermined ranges including the values calculated from the equations (18)-(22) are set. When the U-phase terminal voltage Vu and is in the predetermined range, the microcomputer 70 can determine that abnormality occurs in a corresponding portion. When one of the

MOSFETs 24-26 shorts out or when the V-phase wire breaks, the U-phase terminal voltage Vu=0. Thus, when the microcomputer 70 needs to discriminate which portion among the MOSFETs 24-26 and the V-phase has abnormality, the microcomputer 70 can identify the abnormal portion by executing another process.

The power converter 2 according to the present embodiment can detect abnormality with a simple process in a manner similar to the first embodiment. The winding is three phases and the U-phase voltage detecting portion 51 detects the voltage applied to the U-phase coil 11. The pull-up resistor 262 is coupled between the V-phase coil 12 and the battery line 33 which is the high-potential side of the battery 31. The pull-down resistor 263 is coupled between the W-phase coil 13 and the ground line 34 that is the low-potential side of the battery 31. Because the microcomputer 70 detects abnormality only based on the voltage applied to the U-phase coil 11, the process of determining abnormality becomes simpler. In addition, because the applied voltage is detected at only one phase of the wirings, the number of components for detecting the voltage can be further reduced.

In the present embodiment, the microcomputer 70 can function as an abnormality detecting portion in a manner similar to the first embodiment. The process at S104 in FIG. 2 corresponds to a process as a function of the abnormality detecting portion.

### Third Embodiment

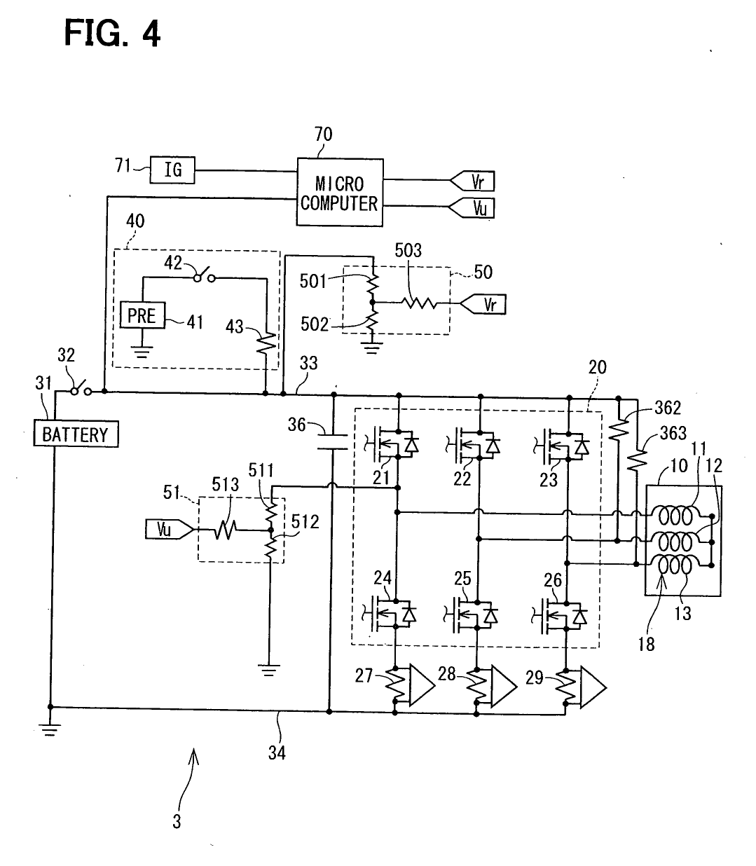

A power converter 3 according to a third embodiment will be described with reference to FIG. 4. In the power converter 3 according to the present embodiment, the. microcomputer 70 detects only a voltage applied to the U-phase coil 11 and does not detect a voltage applied to the V-phase coil 12 and a voltage applied to the W-phase coil 13.

Between the V-phase coil 12 and the high-potential side of the battery 31, a pull-up resistor 362 is disposed. The pull-up resistor 362 couples the battery line 33 and the V-phase coil 12 on the downstream side of the power source relay 32. Between the W-phase coil 13 and the high-potential side of the battery 31, a pull-up resistor 363 is disposed. The pull-up resistor 363 couples the battery line 33 and the W-phase coil 13 on the downstream side of the power source relay 32. Thus, in the present embodiment, the V-phase and the W-phase are pulled up by the pull-up resistors 362, 363. Each of the pull-up resistors 362, 363 corresponds to a resistor.

Examples of resistances of respective resistors included in the power converter 3 are described below. The pull-up resistor 362 has a resistance RpullV of 4120 Ω, and the pull-up resistor 363 has a resistance RpullW of 4120 Ω Thus, in the present embodiment, the pull-up resistors 362, 363 have the same resistance. In the U-phase voltage detecting portion 51, the resistor 511 has a resistance RupU of 1500 Ω, the resistor 512 has a resistance RdownU of 1000 Ω, and the resistor 513 has a resistance of RdampU of 2400 Ω. The U-phase coil 11 has a resistance RmU of 0:01 Ω, the V-phase coil 12 has a resistance RmV of 0.01 Ω, and the W-phase coil 13 has a resistance RmW of 0.01 Ω.

An abnormality detecting process according to the present embodiment is almost similar to the abnormality detecting process shown in FIG. 2. Thus, only a part different from the first embodiment will be described and a description about the other part will be omitted. At S104, the microcomputer 70 acquires the U-phase terminal voltage Vu from the U-phase voltage detecting portion 51 and determines whether the U-phase terminal voltage Vu is normal. The U-phase terminal voltage Vu in the normal state can be calculated from the following equation (23).

Vu=Vba×(RdownU)/(Rp3+RupU+RmU+RdownU) (23).

Where, Rp3 is a combined resistor of the pull-up resistor 362, the V-phase coil 12, the pull-up resistor 363, and the W-phase coil 13. Rp3 can be calculated from the following equation (24).

Rp3={(RpullV+RmV)×(RpullW+RmW)}/{(RpullV+RmV)+(RpullW+RmW)} (24)

In a case where the battery voltage Vba is 12 V and each resistor has the above-described resistance, the U-phase terminal voltage Vu in the normal state is 2.63 V.

In the present embodiment, the microcomputer 70 determines that the U-phase terminal voltage Vu is normal when the U-phase terminal voltage Vu is in a predetermined range including 2.63 V. For example, the microcomputer 70 determines that the U-phase terminal voltage Vu is normal when 2.4≦Vu≦2.8. When the microcomputer 70 determines that the U-phase terminal voltage Vu is not normal, which corresponds to “NO” at S104, that is, when Vu<2.4 or Vu>2.8, the process proceeds to S108. When the microcomputer 70 determines that the U-phase terminal voltage Vu is normal, which corresponds to “YES” at S104, the process proceeds to S105. At S106, the microcomputer 70 determines whether the U-phase voltage Vu at when the MOSFETs 21-26 are driven at 50% phase by phase is normal in a manner similar to the second embodiment.

Next, a method of determining an abnormal portion based on the U-phase terminal voltage Vu at when the power source relay 32 is in the on-state and the precharge relay 42 is in the off-state will be described. When one of the MOSFETs 21-23 shorts out, the U-phase terminal voltage Vu can be calculated from the following equation (25).

Vu=Vba×{(RdownU)/(RupU+RdownU)} (25)

In a case where the battery voltage Vba is 12 V and each resistor has the above-described resistance, the U-phase terminal voltage Vu at when one of the MOSFETs 21-23 shorts out is 4.80 V. The U-phase terminal voltage Vu at when one of the MOSFETs 24-26 shorts out becomes a value calculated from the following equation (26).

Vu=0 (26).

The U-phase terminal voltage Vu at when the U-phase wire breaks becomes a value calculated from the following equation (27).

Vu=0 (27).

The U-phase terminal voltage Vu at when the V-phase wire breaks can be calculated from the following equation (28).

Vu=Vba×(RdownU)/(RpullW+RmW+RupU+RmU+RdownU) (28).

The U-phase terminal voltage Vu at when the W-phase wire breaks can be calculated from the following equation (29).

Vu=Vba×(RdownU)/(RpullV+RmV+RupU+RmU+RdownU) (29).

In a case where the Vba is 12 V and each resistor has the above-described resistance, the U-phase terminal voltage Vu at when the V-phase wiring breaks is 1.81 V, and the U-phase terminal voltage at when the W-phase wiring breaks is 1.81 V.

As shown in the equations (25)-(29), the U-phase terminal voltage Vu at when the power source relay 32 is in the on-state and the precharge relay 42 is in the off-state has a different value in accordance with an abnormal portion. Thus, the microcomputer 70 can identify the abnormal portion based on the U-phase terminal voltage Vu. For example, predetermined ranges including the values calculated from the equations (23)-(29) are set. When the U-phase terminal voltage Vu is in the predetermined range, the microcomputer 70 can determine that abnormality occurs in a corresponding portion. When one of the MOSFETs 24-26 shorts out or when the U-phase wiring breaks, the U-phase terminal voltage Vu=0. Because the pull-up resistors 362, 363 have the same resistance, the U-phase terminal voltage Vu at when the V-phase wiring breaks and the U-phase terminal voltage Vu at when the W-phase wiring breaks are equal to each other. When the microcomputer 70 needs to discriminate between a case where the V-phase wiring breaks and a case where the W-phase wiring breaks, the microcomputer 70 may identify an abnormal portion with another process. In the present embodiment, the pull-up resistors 362, 363 have the same resistance. Thus, in a case where the determination of an abnormal portion is not required or when the determination of an abnormal portion is performed in another process, a range between an upper limit and a lower limit for determining abnormality can be increased and the determination of abnormality becomes easy.

The power converter 3 according to the present embodiment can have effects similar to the effects of the first embodiment. The U-phase voltage detecting portion detects the voltage applied to the U-phase coil 11. The pull-up resistor 362 is disposed between the V-phase coil 12 and the battery line 33 which is the high-potential side of the battery 31. The pull-up resistor 363 is disposed between the W-phase coil 13 and the battery line 33 which is the high-potential side of the battery 31. Because the power converter 3 detects abnormality only based on the voltage applied to the U-phase coil 11, the process for determining abnormality can be further simplified. In addition, because the number of position at which the voltage applied to the coils 11-13 is detected is only one, the number of components for detecting the voltage can be further reduced.

In the present embodiment, the microcomputer 70 can function as an abnormality detecting portion in a manner similar to the first embodiment. The process at S104 in FIG. 2 corresponds to a process as a function of the abnormality detecting portion.

### Fourth Embodiment

A power converter according to a fourth embodiment will be described below. The present embodiment is a modification of the third embodiment. In the present embodiment, the pull-up resistor 362 and the pull-up resistor 363 have different resistances. For example, the pull-up resistor 362 has a resistance RpullV of 6000 Ω and the pull-up resistor 363 has a resistance RpullW of 3000 Ω. In the U-phase voltage detecting portion 51, the resistor 511 has a resistance RupU of 1000 Ω, the resistor 512 has a resistance RdownU of 1000 Ω, and the resistor 513 has a resistance of RdampU of 2400 Ω. The U-phase coil 11 has a resistance RmU of 0.01 Ω, the V-phase coil 12 has a resistance RmV of 0.01 Ω, and the W-phase coil 13 has a resistance RmW of 0.01 Ω.

The U-phase terminal voltage Vu in the normal state can be calculated from the equation (23). In a case where the battery voltage Vba is 12 V and each resistor has the above-described resistance, the U-phase terminal voltage Vu in the normal state is 3.00 V. In the present embodiment, at S104 in FIG. 2, the microcomputer 70 determines that the U-phase terminal voltage is normal when the U-phase terminal voltage Vu is in a predetermined range including 3.00 V. For example, the microcomputer 70 determines that the U-phase terminal voltage Vu is normal when 2.7≦Vu≦3.3, and the microcomputer 70 determines that the U-phase terminal voltage Vu is not normal when Vu<2.7 or Vu>3.3.

In the present embodiment, the resistance RpullV of the pull-up resistor 362 and the resistance RpullW of the pull-up resistor 363 have different values. Thus, the U-phase terminal voltage Vu at a breaking of the V-phase wiring calculated from the equation (28) is different from the U-phase terminal voltage Vu at a breaking of the W-phase wiring calculated from the equation (29). In a case where the battery voltage Vba is 12 V and each resistor has the above-described resistance, the U-phase terminal voltage Vu at a breaking of the V-phase wiring calculated from the equation (28) is 2.40 V. The U-phase terminal voltage Vu at a breaking of the W-phase wiring calculated from the equation (29) is 1.50 V. Accordingly, in addition to the portions which can be identified in the third embodiment, a breaking of the V-phase wiring and a breaking of the W-phase wiring can be identified based on the U-phase terminal voltage Vu. It is preferable that the resistances of the pull-up resistors are determined so that difference among the U-phase terminal voltage in the normal state, the U-phase terminal voltage Vu at a breaking of the U-phase wiring, the U-phase terminal voltage Vu at a breaking of the V-phase wiring, and the U-phase terminal voltage Vu at a breaking of the W-phase wiring can be large.

The power converter according to the present embodiment can have effects similar to the effects of the third embodiment. The pull-up resistors 362 and 363 have different resistances. In other words, the resistances of the pull-up resistors 362, 363 provided to correspond to the wiring of each phase are different from each other. Accordingly, the voltage detected by the U-phase voltage detecting portion 51 changes in accordance with an abnormal portion, the power converter can easily identify an abnormal portion.

### Other Embodiments

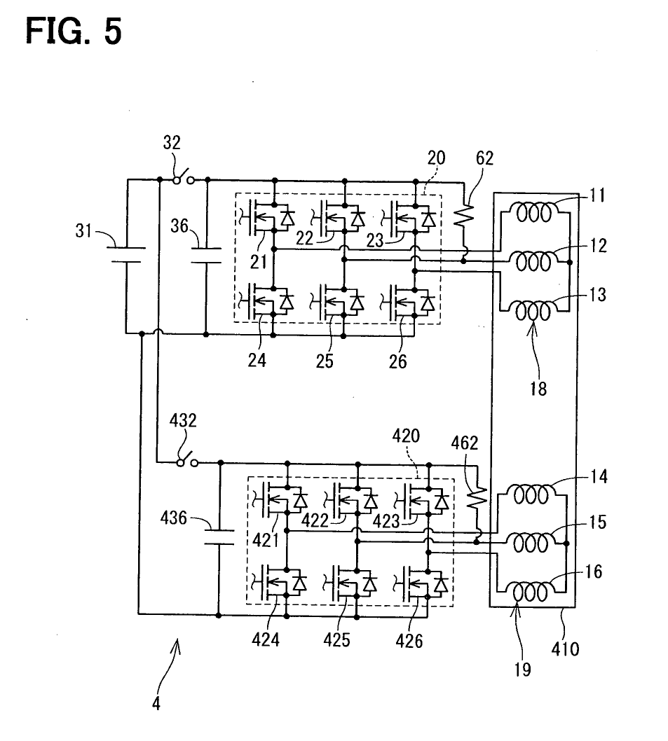

In the above-described embodiment, each power converter includes one set of windings and one inverter section. The number of set of windings and the number of inverter section may also be more than one. An example of a power converter 4 in a case where the number of set of windings and the number of inverter section are more than one will be described with reference to FIG. 5. In FIG. 5, voltage detecting portions, a precharge circuit, and a microcomputer are not shown. A motor 410 includes a set of windings 18 and a set of windings 19 which have similar structures. The power converter 4 includes inverter sections 20, 420, power source relays 32, 432, capacitors 36, 436, and pull-up resistors 62, 462. The inverter section 20 includes MOSFETs 21-26, and the inverter section 420 includes MOSFETs 421-426. The inverter section 20 and the inverter section 420 have similar structures, the MOSFETs 21-26 and the MOSFETs 421-426 have similar structures, the power source relay 32 and the power source relay 432 have similar structures, the capacitor 36 and the capacitor 436 have similar structures, and the pull-up resistor 62 and the pull-up resistor 462 have similar structures.

In the motor 410, the set of windings 18 includes a U-phase coil 11, a V-phase coil 12, a W-phase coil 13, and the set of windings 19 includes a U-phase coil 14, a V-phase coil 15, and a W-phase coil 16. The inverter section 20 switches power supply to the set of windings 18. The inverter section 420 switches power supply to the set of windings 19. The pull-up resistors 62, 462 are provided to the V-phase coils 12, 15, respectively, in a manner similar to the first embodiment. U-phase voltage detecting portions and W-phase voltage detecting portions, which are not shown, detect voltages applied to the U-phase coil 11, the W-phase coil 13, the U-phase coil 11, and the W-phase coil 16. The microcomputer, which is not shown, detects abnormality based on the detected voltage. In the present embodiment, the microcomputer detects abnormality in a system related to the set of windings 18 based on the voltage applied to the U-phase coil 11 and the voltage applied to the W-phase coil 13 and detects abnormality in a system related to the set of windings 19 based on the voltage applied to the U-phase coil 14 and the W-phase coil 16. Accordingly, the power converter 4 can have effects similar to the effects of the above-described embodiment. Because a power converter can detect abnormality based on a voltage applied to a winding in a phase which do not have a resistor with a power source, in a case where the number of set of windings and the number of inverter section are more than one, an effect of reducing the number of components for detecting the voltages applied to the windings can be large.

In the power converter 4, the pull-up resistors are provided to the V-phases in a manner similar to the first embodiment. However, the power converter 4 may be modified in such a manner that pull-up resistors are provided to the V-phases and pull-down resistors are provided to the W-phases and the voltages applied to the U-phases are detected in a manner similar to the second embodiment. The power converter 4 may also be modified in such a manner that the pull-up resistors are provided to the V-phases and the W-phases and the voltages applied to the U-phases are detected in a manner similar to the third embodiment. By the above-described configuration, the number of components for detecting the voltages applied to the windings can be reduced. In a case where the pull-up resistors are provided to two phases, the pull-up resistors may have the same resistance in a manner similar to the third embodiment, and the pull-up resistors may have different resistances in a manner similar to the fourth embodiment. In a case where the windings and the inverter sections are multiple system, the number and arrangement of the resistors can be changed with system.

In the first embodiment, the voltages applied to the U-phase coil and the W-phase coil are detected, and the pull-up resistor is provided to the V-phase. The pull-up resistor may be provided to any phase and the voltage detecting portions may be configured to detect the voltages applied to the windings of the phases to which the pull-up resistor is not provided. In the second embodiment, the voltage applied to the U-phase coil is detected, the pull-up resistor is provided to the V-phase, and the pull-down resistor is provided to the W-phase. The phase whose voltage is detected may be any phase and the pull-up resistor may be provided to one of the phases whose voltage is not detected, and the pull-down resistor may be provided to the other of the phases whose voltage is not detected. In the third embodiment, the voltage applied to the U-phase coil is detected, and the pull-up resistors are provided to the V-phase and the W-phase. The phase whose voltage is detected may be any phase and the pull-up resistors may be provided to the other phases whose voltages are not detected.

In the above-described embodiments, the windings are three phases, and the three phase inverter is used. The number of phases is not limited to three and may also be two or more than three. In a case where the windings are two phases, a voltage applied to a winding of one phase is detected and a pull-up resistor is disposed between a winding of the other phase and a high-potential side of a power source.

In a case where the windings are n-phases (N≧3), voltages applied to windings of M-phases (1≦M<N) is detected. A resistor is disposed between each of the windings of (N−M) phases whose voltage is not detected and a high-potential side or a low-potential side of a power source. That is, (N−M) sets of resistors are provided. When at least one of the resistors is a pull-up resistor disposed between the winding and the high-potential side of the power source, the number of pull-up resistors and the number of pull-down resistors disposed between the windings and the low-potential side of the power source may be decided optionally. Also by this configuration, abnormality can be detected based on the detected voltage.

In the above-described embodiments, at S103 in FIG. 2, the power source relay 32 is turned on and the precharge relay 42 is turned off. At S103, the power source relay 32 may also be turned off and the precharge relay 42 may also be turned on. In this case, the precharge battery voltage Vpre is used instead of the battery voltage Vba in the equations (1)-(29). In other words, Vba in the equations (1)-(29) is replaced with Vpre, and presence of abnormality and an abnormal portion are determined based on the calculated terminal voltage and the terminal voltage detected by the voltage detecting portion. In the above-described embodiments, the precharge relay 42 is turned on at S101. Thus, the capacitor 36 is charged at S103. In this way, in a case where the capacitor 36 is charged, the process at S104 in FIG. 2 may also be performed with turning off the precharge relay 42.

In the above-described embodiments, the motor as the rotating electric machine is used for an electromotive power steering apparatus. The motor may also be applied to an apparatus other than the electromotive power steering apparatus. The rotating electric machine is not limited to the motor and may also be a generator.

The present invention is not limited to the above-described embodiments and various changes and modifications can be performed within the scope of the present invention.

What is claimed is:

1. A power converter for converting power supplied from a power source to a rotating electric machine, the rotating electric machine including windings of N-phase, where N is an integer that satisfies a relationship of N≧2, the power converter comprising:
an inverter section including an N-pair of switching devices, each pair of switching devices including a high-potential side switching device and a low-potential side switching device, the high-potential side switching device coupled with a high-potential side of the power source and the low-potential side switching device coupled with a low-potential side of the power source, each pair of switching devices coupled with a corresponding one of the windings of N-phase;
a voltage detecting portion configured to detect a voltage applied to each of the windings of M-phase, where M is an integer that satisfies a relationship of 1≦M<N;
one or more resistors, each of the resistors coupled between a corresponding one of the windings of (N−M)-phase whose voltage is not detected and a high-potential side or a low-potential side of the power source; and
an abnormality detecting portion configured to detect abnormality based on the voltage detected by the voltage detecting portion, wherein
at least one of the resistors is coupled between the corresponding winding and the high-potential side of the power source.

2. The power converter according to claim 1, wherein:
M is (N−1);
the voltage detecting portion configured to detect the voltage applied to each of the windings of (N−1)-phase; and
the resistor is disposed between the winding of one-phase whose voltage is not detected and the high-potential side of the power source.

3. The power converter according to claim 1, wherein:
M is one;
the voltage detecting portion configured to detect the voltage applied to the winding of one-phase; and
each of the resistors is disposed between a corresponding one of the windings of (N−1)-phase whose voltage is not detected and the high-potential side of the power source.

4. The power converter according to claim 3, wherein
the resistors have resistances different from each other.

5. The power converter according to claim 1, wherein
N is three.

6. The power converter according to claim 1, wherein:
N is three, M is one;
the windings of three-phase include a first winding, a second winding, and a third winding;
the resistors include a first resistor and a second resistor;
the voltage detecting portion detects the voltage applied to the first winding;
the first resistor is coupled between the second winding and the high-potential side of the power source; and
the second resistor is coupled between the third winding and the low-potential side of the power source.
